(19) United States
(12) Patent Application Publication
(10) Pub. No.: US 2010/0127832 A1
(43) Pub. Date: May 27, 2010

(54) STRUCTURAL COMPONENT BASED ON A CERAMIC BODY

(75) Inventors: Stefan Pischek, Honigsberg (AT); Stefan Pirker, Villach (AT); Artur Erlacher, Velden (AT); Rene Fachberger, Villach (AT); Michael Ressmann, Ledenitzen (AT)

Correspondence Address: WALKER & JOCKE, L.P.A., 231 SOUTH BROADWAY STREET, MEDINA, OH, 44256, US

(73) Assignee: REFRACTORY INTELLECTUAL PROPERTY GMBH & CO. KG, Wien (AT)

(21) Appl. No.: 12/595,371

(22) PCT Filed: Apr. 12, 2008
(86) PCT No.: PCT/EP08/02905

§ 371 Date: Nov. 19, 2009

(30) Foreign Application Priority Data
May 5, 2007 (DE) 10 2007 021 172.6

(51) Int. Cl. H04Q 5/22; G06F 15/00

(52) U.S. Cl. 340/10.1; 702/188

(57) ABSTRACT

The invention relates to a component based on a ceramic material that is stable to the greatest possible extent at elevated temperatures, especially temperatures exceeding 800° C. (i.e. the component can achieve the intended purpose thereof at said temperature).

The invention relates to a structural component based on a ceramic body that is very largely stable at relatively high temperatures, in particular at temperatures above 800° C. (that is to say, the structural component is able to perform its task according to the application at this temperature). The structural component may be unfired. The chemical/ceramic reactions for the purpose of obtaining the temperature resistance (extending up to refractoriness) then arise, for example, only in the course of operation of the structural component. To this extent, the invention encompasses structural components having a temperature resistance also above 900° C., >1000° C., but also >1100° C., >1200° C., >1300° C. and, ultimately, products for high-temperature applications above 1400° C. The structural component may also be tempered or fired. The last-named group encompasses structural components that exhibit a temperature resistance (refractoriness) within the range specified above.

The structural component may consist of a monolithic mass; in particular, however, it is a shaped structural component. Examples of a shaped refractory structural component of the named type are:
bricks of arbitrary shape and size, for example for the refractory lining of an industrial kiln, for example of a ladle, of a tundish, of a glass trough, of a converter, of a cement rotary kiln, of a shaft kiln, of a refuse-incineration plant or such like,
plates, including slide plates for slide shutters, such as are used for regulating/controlling the outflow of metal melt in metallurgical melting vessels,
cones and truncated cones, including gas-purging cones (gas-purging bricks) such as are used for the purpose of supplying gases, mostly inert gases, into metal melts. This group also includes gas-purging bricks of different geometry,
other shapes, for example channels, along which a metal melt is conducted, stoppers for regulating the rate of flow of a melt out of a metallurgical melting vessel, sleeves, well nozzles, well blocks and many others.

The named structural components may be produced from varying materials, for example from a basic batch based on MgO or from a non-basic batch based on Al₂O₃, TiO₂, ZrO₂ and/or SiO₂. The invention is applicable to all material systems. The structural components may be cast, stamped, pressed, or processed in some other way. Their binding system is not subject to any restrictions. The invention accordingly encompasses, for example, C-bound, ceramically or hydraulically bound structural components.

All structural components are subject to wear. Both for processing reasons and for financial reasons, there is a desire to optimise the durability (useful life) of the structural component. Frequently, however, this is not possible, since no information is available about the condition (degree of wear) of the structural component. This applies in particular during operation, since the high application temperatures render an appropriate examination difficult or impossible.

In WO 03/080274 A1 a process is proposed for operating a slide shutter, wherein in the environment of the refractory slide plates one or more of the following parameters is/are determined and evaluated: the dimensions of the slide-shutter system, the temperatures in the region of the slide shutter, the pressures of the cylinders and springs that act on the slide plates. These are all indirect quantities that do not enable a reliable statement about the degree of wear of the structural component.

The object of the invention is to enable an identification of the structural component and to enable statements about the condition or the time of operation of the structural component before, during and after operation.

The following perception underlies the invention: the recording of various characteristic quantities around the actual structural component, as in the state of the art, does not lead to the objective. A slide-shutter plate is generally assembled in a mechanism made of metal. A gas-purging brick is often arranged in a well nozzle, or a nozzle is surrounded by refractory bricks or by a refractory mass (monolithic). The structural component is frequently in contact with a hot melt or material to be fired. Rather, the structural component itself has to be examined. Direct optical-recognition processes are excluded. This also applies to the direct (physical) connection of measuring devices and monitoring devices.

The invention takes a totally different path. It proposes to integrate one or more sensors (for example, 1, 2, 3, 4 or more) into the structural component, in order in this way to record at least one of the following items of information (also) during the operation of the structural component and to be able to transmit said information to a data-processing system:
Information for identifying the structural component. Such information includes, for example, the following data: product type, grades of material, manufacturer details, production date, delivery date and date of operation, etc.
Data about the physical properties of the structural component. Such data include, for example, the temperature of the structural component, mechanical (thermomechanical) stresses in the structural component, etc.
Data about the location and movements of the structural component. This information has significance, in particular, for structural components that are moved during operation—for example, slide plates, stoppers, but also height-adjustable gas-purging bricks, lances or such like. The place where the structural component is located in the plant may also be established.
Data about the time of operation of the structural component: in this connection it is recorded—for example, with the aid of a temperature measurement—how long a slide plate has been ‘in operation’—that is to say, how long metal melt has flowed through the opening in the slide plate.

‘Integrate’ means that the sensor is arranged in or on the structural component.

The aforementioned items of information (data) may be significant individually, but also in arbitrary combinations, for the determination of the condition—for example, the degree of wear—of the structural component. In this connection the items of information are regularly recorded and evaluated not discretely but in time-dependent manner. In the case of several sensors, the data can be recorded at different places on the structural component. Hence it is possible, for example, for a temperature gradient in the structural component to be determined. Similarly, several sensors may be provided in several structural components. Hence it is possible for information from different places to be obtained and evaluated. This will be illustrated on the basis of the example constituted by a slide plate:

Hitherto the operating staff have decided empirically whether or not a used slide plate can be employed once again.

Data about the duration and temperature loading of the slide plate in the course of previous operation are lacking. The operating staff have no reliable information about whether or not mechanical stresses have appeared in the product in the past. If the slide plate is used again, there is a risk that it will no longer withstand undamaged the further service life that is required. In the extreme case, breakouts of metal melt can occur, with catastrophic consequences.

These disadvantages are avoided with a structural component according to the invention. The data communicated by the sensor are recorded and evaluated in a data-processing system. The actual data, or characteristic quantities derived therefrom, are compared with set values. If it is then clear, for example, that the slide plate has already reached 90% of its calculated maximum time of operation, or that mechanical stresses above a predetermined limiting value have arisen in the course of preceding use, said slide plate is exchanged. The sensors are able to indicate discharges of metal in good time by temperature measurement and/or stress measurement, in order to avoid major damage.

Further examples of application are: incorporation of a sensor or of a structural component with a sensor in the bottom or in the wall of a casting ladle or of a different metallurgical melting vessel, in order to monitor the drying of a ceramic lining body. For example, the monolithic has to be heated up to a minimum temperature in order to obtain complete drying.

In the case of gas-purging elements, the degree of wear of the structural component can be inferred in the case of a temperature measurement via sensors. Similarly, it is possible for information about the rate of flow of the gas to be obtained by temperature measurement. The more cool gas is flowing though, the lower the measured temperature.

The sensors may, furthermore, serve to detect or to indicate instances of local overheating in the structural component if a temperature level has been reached at which a physical/chemical reaction such as a phase transition is to be expected.

In its most general embodiment, the invention relates to a structural component based on a ceramic body that is very largely stable at operating temperatures above 800° C., at least one sensor being integrated within the structural component, with which at least one of the following items of information is capable of being recorded during the operation of the structural component and capable of being transmitted to a data-processing system: identification of the structural component, physical properties of the structural component, movements of the structural component, time of operation of the structural component, location of the structural component.

The sensor is ordinarily assembled in a casing, in order to protect it against excessive temperature loading, against contamination and breakage. The casing may consist of glass ceramic, for example.

In principle, for the purposes of the invention any sensor is suitable that is able to record and transmit data of the aforementioned type. For example, semiconductor transponders can be employed that are supplied with current by an evaluating unit via an inductive coupling.

According to one embodiment, the sensor is a passive sensor. This passive sensor is connected to a transmit/receive unit via a radio link. An interrogating signal is sent to the passive sensor by radio. As a result of interaction with the sensor, a response signal is generated which is sent back to the interrogating unit, which now serves as a receiver.

In order, in the receiving unit, to separate the signal sent back by the sensor from the signal given to the sensor, a separating mechanism is required. This is effected, for example, by the signal emitted by the sensor exhibiting a different frequency from that of the signal supplied to the sensor. In addition to the change of frequency, or as an alternative, a time lag between the signals for the purpose of separation can be considered.

If the structural component is in the state of rest, a specific, reproducible signal is sent back. By virtue of pressure, temperature, stress, etc., which act on or in the structural component, the signal changes again in reproducible manner.

According to one embodiment, the sensor therefore includes a device for converting electromagnetic waves into mechanical waves and conversely. To this end, the sensor may be designed with an antenna for wireless reception and for wireless emission of radio signals. In one variant, the sensor is connected via a cable to an antenna which communicates appropriate signals directly to a receiving unit or conversely receives them from the latter. With a view to avoiding negative effects in the course of data transmission, which may arise, for example, by virtue of shielding effects of metal parts in the radio path, the antenna that is assigned to the sensor is preferentially arranged in such a way that no metal parts are situated in the radio path to the transmit/receive unit.

One embodiment of the invention provides that the sensor takes the form of a SAW element (SAW=surface acoustic wave). On the sensor, mechanical surface waves are stimulated, the behaviour of which is changed by action of a physical quantity such as pressure, temperature, stress. This will be elucidated on the basis of an example:

A SAW sensor consists of a piezoelectric substrate crystal, on which metallic structures (reflectors) are applied. The SAW sensor is in radio communication with the transmitter/reader via an antenna. The transmitter/reader emits an electromagnetic signal that is received by the sensor antenna. This signal is converted into mechanical oscillations by a special transducer which is located on the SAW sensor. The waves resulting therefrom propagate on the surface of the piezoelectric crystal. At the aforementioned reflectors the surface waves are partly reflected. Subsequently these surface waves are converted back again into electromagnetic waves. Since the crystal expands or contracts as a function of physical quantities such as, for example, temperature, pressure, stresses, this results in a change in the transit-time of the signal.

An electromagnetic high-frequency pulse is sent to the sensor from a radio control centre. This pulse is received by the antenna of the sensor and converted into a propagating mechanical surface wave by the transducer (for example, an interdigital transducer). The aforementioned reflecting (partly reflecting) structures on the surface of the sensor—which are formed there in a individual, characteristic sequence—are situated in the ray path of these mechanical waves. In this way, from an individual transmitted pulse a plurality of specific pulses arise which are reflected back to the transducer. There they are converted again into electromagnetic waves and sent back to the radio control centre as a response signal by the antenna of the sensor. The response signal contains the desired information about the number and location of the reflectors, the reflection factor thereof, and also the speed of propagation of the acoustic wave. This information is indirect information relating to the identification of the structural component, the physical properties of the structural component, the location and movements of the structural component, and/or the time of operation of the structural component. With the aid of an appropriate calibration, it is possible for the desired data to be calculated in the assigned data-processing system.

The speed of propagation of the acoustic waves amounts typically to only a few 1000 m/s, for example 3500 m/s. Hence the possibility is created of storing a high-frequency pulse on a small chip (sensor) until such time as the electromagnetic ambient echos have died away. The sensor may consist of a piezoelectric crystal or of a piezoelectric lamellar system. The stated structures are vapour-deposited or applied in some other way.

Structural components of the stated type are partly assembled in a metallic jacket or exhibit a metallic covering. For example, slide plates are arranged in metal cassettes and placed in a metallic slide mechanism. The metallic elements bring about a shielding in relation to electromagnetic rays. In this case, in the event of a radio transmission of the data from the sensor to the antenna the invention provides for forming the corresponding metal part (the metallic covering), adjacent to the antenna of the sensor, with a recess for the purpose of passing radio signals through. A further feature is to arrange the sensor in the marginal region of a structural component, in order to enable an optimised radio transmission. The term ‘marginal region’ signifies, for example, the ‘cold side of the structural component’. This is understood to mean the portion of the structural component that is heated least in the course of operation. For example, in the case of a slide plate this is the periphery of a plate, whereas the highest temperatures prevail around the region of the nozzle opening.

In the case of a lining brick for a ladle, this will be the side of the brick adjacent to the outer metallic sheath. In the case of a gas-purging brick, the sensor is preferentially arranged at the end on the gas-inlet side.

In the case of the variant—already mentioned above—with a cable connection between the sensor and the antenna, the number of components is reduced, because a direct data communication to the receive/transmit station is enabled by the sensor antenna, provided that the antenna is positioned at a place that permits an untroubled transmission to the transmit/receive station. The cable may be a flexible high-frequency cable, for example made of copper (Cu) with polytetrafluoroethylene (PTFE) or ceramic as dielectric, as a result of which the temperature resistance is improved.

The sensor may consist at least partly of corrosion-resistant steel, for example a steel of grade 1.4845. Gaskets for the stated applications consist of heat-resistant materials, for example a fluoroelastomer.

The manufacturer of the refractory structural component has calibrating data available, from which it is possible to calculate which temperature at a particular place on the structural component corresponds to which temperature at other places on the structural component. For instance, at a measured temperature of X ° C. in the outer part (periphery) of a slide plate it is possible to infer a temperature in the through-flow region of Y ° C. for a particular material.

As stated, the reflected mechanical waves, or the response signals arising therefrom, enable the evaluation of the desired information, including physical data such as stresses in the structural component, but also the time of operation under temperature load, etc.

By virtue of a floating (‘loose’) incorporation of the sensor, a pure temperature measurement is possible. By virtue of an incorporation of the sensor with a rigid connection in the structural component (that is to say, the structural component and the sensor are permanently connected), further characteristic quantities such as mechanical stresses can be recorded. The measurands can be ascertained separately.

In its most general embodiment the associated monitoring process exhibits the following steps:
emitting a radio signal from a radio control centre to the sensor,
reception of the radio signal by the sensor,
processing, conversion and/or coding of the signal by or in the sensor,
emitting a response radio signal from the sensor to the radio control centre,
evaluation of the radio signals and information communicated thereby, as well as adjustment of this information and/or characteristic quantities ascertained therefrom with set data (reference data) in a data-processing system.

Further features of the process have been described above on the basis of the task and mode of action of the sensor, and will become evident from the features of the dependent claims and the following examples. The features described therein may be essential—individually or in various combinations—for the application of the invention.

The invention will be elucidated below on the basis of various exemplary embodiments, in which connection the Figures have been greatly schematised. Shown are:

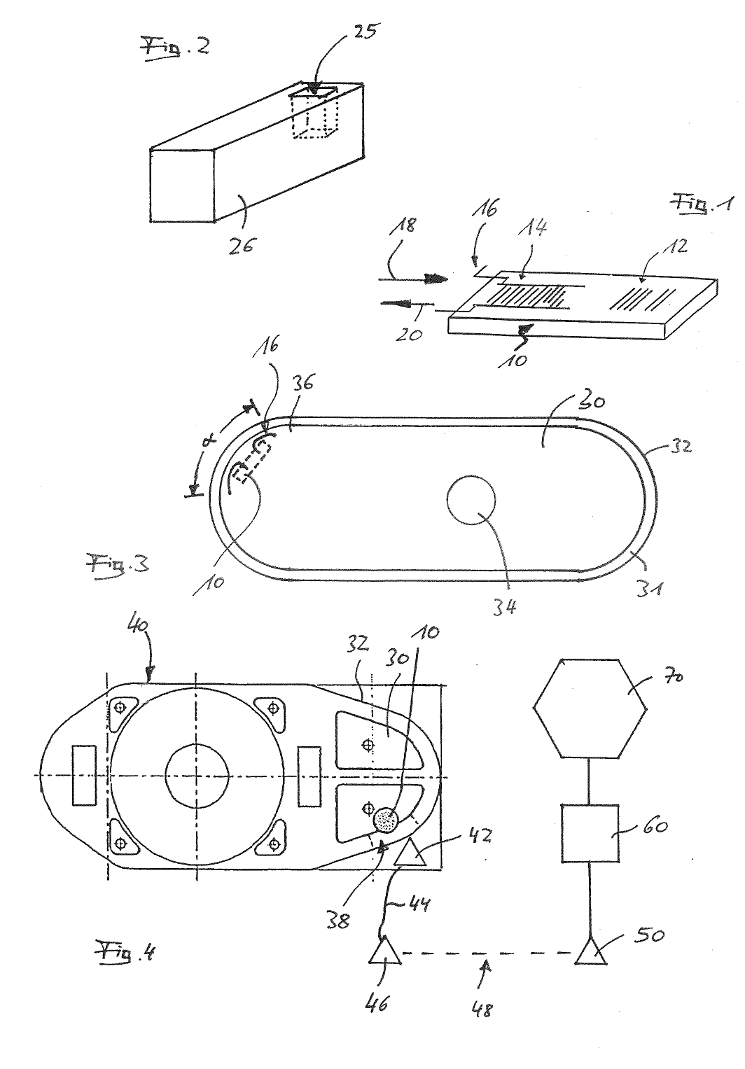

FIG. 1: a perspective view of a piezoelectric sensor crystal

FIG. 2: a perspective view of a refractory structural component in the form of a brick

FIG. 3: a top view of a slide plate assembled in a metallic sheath

FIG. 4: a view of a slide mechanism with inserted slide plate within a monitoring-and-inspection system

In the Figures, identical parts or identically acting parts have been represented with identical reference numerals.

FIG. 1 shows a parallelepipedal piezoelectric crystal (represented without its glass-ceramic casing). Partly reflecting structures 12 have been applied on one of its surfaces, specifically in a characteristic arrangement (specific to the sensor). To be discerned furthermore is an interdigital transducer 14. The electrical connections are guided out of the crystal, in order in this way to connect busbars of the interdigital transducer to an antenna 16. The crystal with its structures 12 and with the transducer 14 constitutes a sensor 10.

An electromagnetic high-frequency pulse (represented schematically by arrow 18) emitted from a control unit (60 in FIG. 4) reaches the sensor 10, is received by the antenna 16, and converted into a propagating mechanical surface wave by the transducer 14. From the interrogating signal a plurality of surface waves arise which are reflected back to the transducer 14 in accordance with the arrangement of the structures 12 at the time of measurement and reconverted into an electromagnetic signal (arrow 20) via the transducer 14. This signal is received by the control unit 60, upstream of which an antenna 50 is connected, and is forwarded to a data-processing unit 70 (FIG. 4) and evaluated.

The sensor 10 according to FIG. 1 may, for example, be inserted into a hollow 25 in a parallelepipedal refractory magnesia brick 26 (FIG. 2) and mortared therein.

FIG. 3 shows the arrangement of the sensor 10 in a slide plate 30 which is mortared into a moveable metallic sheath 32 (mortar joint 31). A casting hole in the slide plate 30 is labelled with 34. At the edge 36 of the slide plate 30 the sensor 10 is worked (surrounded by mortar) into the ceramic material of the slide plate 30. Here the structural component (the specific slide plate) and the temperature thereof are to be identified with the sensor 10. For the purpose of protection, the sensor 10 is arranged in a casing made of glass ceramic. An antenna 16 protrudes above the crystal. An adjacent corresponding portion of the metallic sheath 32 (represented by the angle a in FIG. 3) exhibits opposite the antenna 16 a slotted recess (not discernible), in order to be able to conduct the electromagnetic waves 18, 20 to the antenna 16 from outside and to conduct them away from said antenna.

FIG. 4 shows an associated part of a slide mechanism 40 for accepting the cassette 32 and the slide plate 30. The slide system regulates a flow of steel from a ladle into a downstream tundish.

The sensor 10 with the antenna 16 is represented schematically. The slotted opening in the cassette 32 is indicated by 38. Situated directly opposite the antenna 16 of the sensor (chip) 10 is a further antenna 42 which, via a temperature-resistant coaxial cable 44, is connected to a third antenna 46 which is connected to the aforementioned antenna 50 via a radio link 48. The signal transmission (high-frequency signal) is effected from the control unit 60 via the antenna 50 to the antenna 46 (in wireless manner) and from there (in wire-bound manner) to the antenna 42 and, in turn, in wireless manner to the antenna 16 of the sensor 10. The signal reflected from the sensor 10 reaches the control unit 60 over the inverse path. The sensor 10 is capable of transmitting a signal that contains information about the current temperature and also a previously assigned identification coding. In this connection the sensor 10 receives an electromagnetic pulse (in the GHz frequency range), processes said pulse, and sends back a succession of characteristic electromagnetic pulses. From the temporal separations of these pulses the identification and the temperature can be decoded. The sensor is based on SAW technology and is equipped with the antenna 16 for a radio transmission.

The slide mechanism 40 is made of metal. It is therefore necessary to conduct the electromagnetic signal out of the slide mechanism 40 via a cable. To this end, the antenna 42 is mounted in fixed manner in relation to the antenna 16. The antenna 46 connected via the cable 44 is mounted externally on the slide mechanism 40.

In operation, the control unit 60 transmits electromagnetic signals (pulses) from the antenna 50 to the antenna 46. From the antenna 46 each signal is transmitted via the coaxial cable 44 to the antenna 42 which transmits the signal to the sensor 10 by radio via the antenna 16. The sensor 10 converts the signal into a surface wave which, after reflection on the structures 12, contains information about sensor temperature or the identification of the structural component 30. This pulse train (pulse sequence) is transmitted from the sensor 10 to the control unit 60 via the antennae. The control unit 60 ascertains the identification and the temperature from the number of pulses and from the temporal separations thereof. The data ascertained are transmitted to the data-processing unit 70.

From the data that stem from the sensor the data-processing unit 70 is able to extract or calculate the following information:
Identification function:
   identification of the slide plate 30 prior to operation
   identification of the slide plate 30 during operation
   identification of the slide plate 30 after operation.

On the basis of the identification, the condition of the slide plate 30 can be linked with data pertaining to the steelworks.
Temperature measurement:
   determination of the casting-time and service life by evaluation of the temperatures at particular times
   number of thermal shocks by analysis of the temperatures at certain times
   exceeding, undershooting or reaching critical temperature-ranges, for example phase-transition temperature of zirconium oxide in the slide plate 30 at 1050° to 950°
   early recognition of irregularities, for example breakouts.

All the transmitted/received signals are registered and evaluated by the connected data-processing system 70.

The example according to FIG. 4 can be modified as follows. Instead of the sensor 10 with radio communication to the antenna, use is made of a rod-type sensor which is connected to an antenna via a cable. In this case the sensor is situated in the slide plate—that is to say, on the ‘hot side’; the antenna is situated at a distance therefrom in a region where lower temperatures prevail. Bridging of the metal cassette of the slide plate is effected with the aid of the cable. The antenna is arranged in such a way that there is a trouble-free radio communication to the antenna 50 of the control unit 60. In this embodiment the antennae denoted in FIG. 4 by 42 and 46 are superfluous.

1. Structural component based on a ceramic body that is very largely stable at temperatures above 800° C., at least one sensor (10) being integrated within the structural component (26, 30), with which at least one of the following items of information is capable of being recorded and transmitted to a data-processing system (70) during the operation of the structural component (26, 30): identification of the structural component (26, 30), physical properties of the structural component (26, 30), movements of the structural component (30), time of operation of the structural component (26, 30), location of the structural component (26, 30).

2. Structural component according to claim 1, the sensor (10) of which is assembled in a casing.

3. Structural component according to claim 2, the casing of which is made of glass ceramic.

4. Structural component according to claim 2, the casing of which does not shield electromagnetic waves.

5. Structural component according to claim 1, the sensor (10) of which is a passive sensor.

6. Structural component according to claim 1, the sensor (10) of which is designed with an antenna (16) for wireless reception and for wireless emission of radio signals.

7. Structural component according to claim 1, the sensor (10) of which is designed with an antenna (16) for emission of radio signals via a cable.

8. Structural component according to claim 1, the sensor (10) of which exhibits a device (14) for converting electromagnetic waves into mechanical waves and conversely.

9. Structural component according to claim 1, the sensor (10) of which exhibits surface structures (12) which reflect mechanical surface waves.

10. Structural component according to claim 1, the sensor (10) of which exhibits a device for receiving and for emitting high-frequency signals.

11. Structural component according to claim 1, the sensor (10) of which includes a piezoelectric crystal.

12. Structural component according to claim 6, which exhibits, adjacent to the sensor (10), a metallic covering (32), the covering (32) exhibiting, adjacent to the antenna (16) of the sensor (1), a recess (28) for the purpose of passing radio signals through.

13. Process for monitoring a structural component according to claim 1, with the following steps:
13.1 emitting a radio signal from a radio control centre to the sensor,
13.2 reception of the radio signal by the sensor,
13.3 processing, conversion and/or coding of the signal by or in the sensor,
13.4 emitting a response radio signal from the sensor to the radio control centre,
13.5 evaluation of the radio signals and of information communicated thereby as well as adjustment of this information and/or of characteristic quantities ascertained therefrom with set data in a data-processing system.

14. Process according to claim 13, wherein the radio signals transmitted and received by the radio control centre are electromagnetic waves.

15. Process according to claim 14, wherein the sensor converts the received electromagnetic waves into mechanical surface waves via a transducer and relays said waves via the surface of the sensor which is designed with reflecting surface structures which reflect the mechanical surface waves at least partly back to the transducer which converts these mechanical surface waves into electromagnetic waves again and sends said waves back to the radio control centre.

16. Process according to claim 13, wherein signals transmitted and received by the radio control centre are evaluated by the data-processing system, compared with set values, and indicated.
